(19) United States
(12) Patent Application Publication
(10) Pub. No.: US 2025/0204504 A1
(43) Pub. Date: Jun. 26, 2025

(54) Predatory Fishing Lure

(71) Applicants: Justin Cope, Newcastle, CA (US); Mark Heer, Auburn, CA (US)

(72) Inventors: Justin Cope, Newcastle, CA (US); Mark Heer, Auburn, CA (US)

(21) Appl. No.: 18/391,630

(22) Filed: Dec. 20, 2023

(51) Int. Cl. A01K 83/06; A01K 85/00; A01K 85/01

(52) U.S. Cl. CPC A01K 83/061; A01K 85/011; A01K 85/018; A01K 85/1837; A01K 85/1847

(57) ABSTRACT

A predatory fishing lure specifically designed to replicate a wounded baitfish by providing a specific bend in both the lure body and/or the tail wherein having the lure head and the fish head configured to secure together to form a cavity to accommodate a baitfish species and/or fish scent, bait chunks and/or other accessories. Moreover, having the second component of a baitfish body strap configured to engage with baitfish species lower body portion to firmly hold the body of the baitfish to the predatory fishing lure. In addition, the fishing leader is threaded through the lure nose, lure body and existing through the caudal fin allowing for the free movement of the lure to slide up the line once a fish is hooked, to not create a wedge or pivot point for the hook to be dislodged from the predatory fish's mouth. A further object is to provide a predatory fishing lure made of a hard polymeric plastic material includes a realistic lure head portion, with gills and realistic fish eyes an outer surface which may contain coloring or textures a caudal fin, dorsal fin, and an anal fin are allowed to protrude continuously in an integrated manner from the lure body and these fins may contain coloring or textures so as to give parallel linear irregularities.

### STATEMENT REGARDING FEDERALLY SPONSORED RESEARCH OR DEVELOPMENT

Not Applicable

### REFERENCE TO A “MICROFICHE APPENDIX”

Not Applicable.

### FIELD OF THE INVENTION

The present invention relates generally to a predatory fishing lure apparatus and methods, and more specifically, to a fishing lure configured to simulate a wounded baitfish natural movement through the water.

### BACKGROUND OF THE INVENTION

Fishing lures have been around since antiquity and were first made from bone and bronze. The Chinese and Egyptians used fishing rods, hooks, and lines as early as 2,000 B.C.E. The first hooks were made from bronze and were solid and thin. The Chinese were the first to make fishing lines spun from fine silk. During the mid-19th century, lure fishing took off in a big way. Because of this, fishing lures were manufactured on a mass scale. The lures were very basic in design, which is why they were so successful. Today, most lures are made to look like dying, injured, or fast-moving fish.

A universally accepted method of catching fish is commonly referred to as angling, wherein a rod and reel combination is used for tethering a lure at the end of the fishing line. While the use of a rod and reel combination is commonplace, countless types of lures have been used by fishing hobbyists and professionals to entice a fish to take the bait. Further, lures are versatile in that they can be tailored to attract a particular type of fish by changing one or more characteristics, for example, the color, shape, or size.

Given a choice, most anglers and professional fisherman would fish live bait for everything, but sometimes, anglers and professional fisherman deliberately choose dead bait or cut bait, which refers to various types of bait that are cut into strips or used as a whole. Dead bait can be deployed exactly where and how it needs to be fished, whereas live bait can swim out of the target zone or tangle another line. In addition, the scent of fresh dead bait can prove more attractive to predators than the nervousness of live bait. Some predators also prefer an easy meal over chasing a live baitfish.

While on fishing excursions, anglers and professional fisherman often times find it difficult to maintain a dead baitfish while trolling. The baitfish would become unsightly, skin would tear, mouth would be stuck wide open, and the roll of the baitfish would flatten out. They also were difficult to rig because they needed accessories like extra rubber bands to attach the hooks to the baitfish or toothpicks to secure the fishing line and the baitfish to itself. If bait become damaged it render the lure useless until angler changes the bait.

Many anglers and professional fisherman will put their skills to the test and pursue a trophy predatory fish. Over the years, many items have been developed to help improve the sport in many ways. The traditional fishing lure has evolved over time to become an ever-more proficient tool that is critical to catching many different forms of fish. Many different types of lures exist on the market today, each generally designed to excel at catching a specific set or sets of fish within either freshwater, salt water, or both.

Even though fish throughout the world were different, predators and baitfish always acted true to form. Big fish aggressively pursue wounded baitfish. That's why the present invention is designed to work as a replica of a wounded baitfish such as herring, minnow, anchovy or sardine. Its primary target was originally designed to catch salmon; however, we have found that many fish are attracted to the roll of a wounded baitfish.

### BRIEF DESCRIPTION OF THE INVENTION

The primary object of the present invention is to provide a predatory fishing lure that is exactly shaped like a baitfish and simulates the natural roll of a wounded baitfish by providing a specific bend in both the lure body and/or the tail. Specifically, the present invention provides an artificial fishing lure that is simple in construction and configured to naturally accept the shape of a baitfish when attached to the predatory fishing lure enabling the continued natural movement of the lure even after insertion of the bait.

A further object is to provide a predatory fishing lure or the like that includes a realistic lure head portion, with gills and realistic fish eyes and having a main lure body includes a caudal fin, dorsal fin, and an anal fin to imitate the appearance of a baitfish species. In addition, the present invention may have a separated head portion thereof means for attachment of bait chamber in the shape of the other half of the lure head connected by a hinged and locking mechanism securing the two halves resulting in giving access to the baitfish, scent pad and weight holding chamber.

Another object of the present invention relates to a fishing lure having front section configured to assume the shape of a baitfish head with a first chamber located within said section and a second chamber configured to assume the shape of the other half of a baitfish head having access by a hinge and locking mechanism to receive and secure baitfish, fish scent, bait chunks and/or other accessories. In addition, there may be attachment spikes to secure the head of the baitfish to the predatory fishing lure located inside the bait head chamber.

The predatory fishing lure further comprises a tail section having the second component of an elongated baitfish locking mechanism configured to engage with baitfish lower body portion to firmly hold the body of the baitfish to the predatory fishing lure.

Further, a third aspect of the present invention is the head chamber in which a removable scent pad can be used in lieu of an actual baitfish to add scent attractant, chum, or pieces of baitfish inside the head chamber and the scent may be released thru the gill vents on each side of the head.

While there are many adequate fishing lures, many have disadvantages that reduce their usefulness by being complicated, difficult to use, expensive to produce, and of limited design flexibility. The predatory fishing lure may be enhanced by sized, shaped, textured, grooved, body rotation and tail twist to give a more realistic appearance and affect the present invention behavior in the water.

These and other features and advantages of the invention will be readily apparent from the following detail description of an embodiment thereof and reference to the accompanying drawing.

### BRIEF DESCRIPTION OF THE DRAWING

FIG. 1 is a perspective outside view illustrating the predatory fishing lure with the baitfish fully inserted and locked to the head and body portion according to an embodiment of the present invention.

FIG. 2 is a inside view of the invention of FIG. 1 which shows the process in which a baitfish is inserted into the lure body of the present invention.

FIG. 3 is an illustrated view of the invention in accordance with the present embodiment of the invention.

FIG. 4 is a perspective view of a preferred embodiment of the predatory fishing lure showing the major components of the present invention.

FIG. 5 is a side view of the invention, in the open position prior to the insertion into and engagement with the baitfish.

FIGS. 6 and 6A is a top view of the predatory fishing lures of FIG. 1 illustrating an embodiment of the swim characteristic manipulating bend design.

FIG. 7 is a top view of the predatory fishing lures of FIG. 1 whereas the tail portion is an alternative embodiment of the swim characteristic manipulating twist design.

FIG. 8 is a side view of the predatory fishing lures of FIG. 1 showing another alternative embodiment of the swim characteristic manipulating downward/upward design.

FIG. 9 is an enlarged, detail side view of the head portion showing the hinge and locking mechanism for use with the baitfish of the present invention.

FIG. 9A is side view of FIG. 9 of the baitfish fully inserted before engaging the hinge and locking mechanism of the present invention.

FIG. 10 is an enlarged, detail side view of the tail portion showing the hinge and locking mechanism for use with the baitfish of the present invention.

FIG. 10A is the side view of FIG. 9 of the baitfish fully inserted before engaging the hinge and locking mechanism of the present invention.

FIG. 11 is a perspective view of one embodiment of the present invention, showing the scent pad feature before engaging the hinge and locking mechanism of the present invention.

FIG. 11A is a perspective view of the invention with the scent pad inserted and locked to the head and body portion.

FIG. 12 is a perspective view of one embodiment of the present invention, showing the weight feature before engaging the hinge and locking mechanism of the present invention.

FIG. 12A is a perspective view of the invention with the weight inserted and locked to the head and body portion.

FIG. 13 is a perspective view illustrating the predatory fishing lures in use according to an embodiment of the present invention.

### DESCRIPTION OF CERTAIN EMBODIMENT OF THE PRESENT INVENTION

In the following detailed description of the preferred embodiment, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

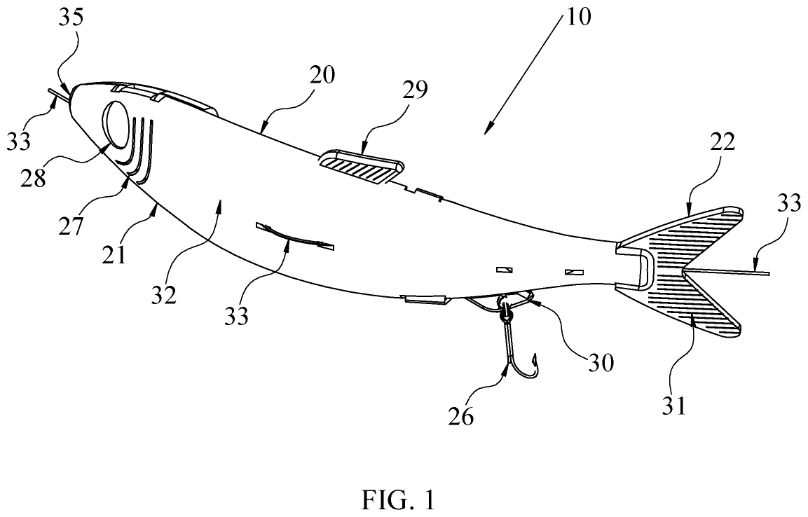

The present invention shown in FIG. 1 is an illustrated view of the predatory fishing lure 10, including the lure body 20 has a realistic lure head portion 21, with gills 27 and realistic fish eyes 28 and the main lure body 20 includes a caudal fin 22, dorsal fin 29, and an anal fin 30 to imitate the appearance of a baitfish species. Whereas, caudal fin 22, dorsal fin 29, and an anal fin 30 are allowed to protrude continuously in an integrated manner from the lure body 20 and these fins may contain coloring or textures 31 (not shown) so as to give parallel linear irregularities. The lure body 20 has an outer surface 32 which may contain coloring or textures to replicate prey fish species. In addition, the fishing leader 33 is threaded through the lure nose 35, lure body 20 and existing through the caudal fin 22. The design allows for the free movement of the lure to slide up the line once a fish is hooked, to not create a wedge or pivot point for the hook to be dislodged from the predatory fish's mouth. Whereas, the predatory fishing lure 10 may be made of any materials commonly used in the manufacturing of fishing lures but preferably made of a hard polymeric plastic material. To aid in capturing a fish, in which the fish has contact with the predatory fishing lure 10, a hook 26 and/or hooks may be secured to the lure body 20. The hook(s) 26 is preferably a standard fishhook.

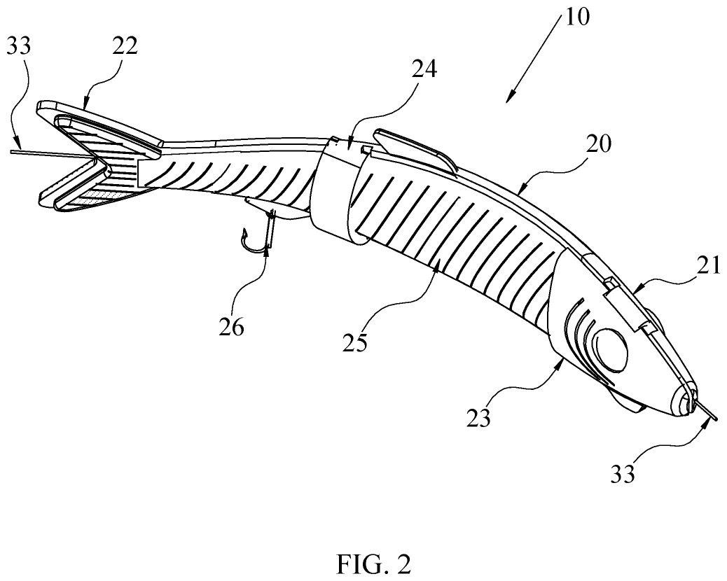

As shown in FIG. 2 perspective view the predatory fishing lure 10 specifically designed to replicate a wounded baitfish 25 fleeing an attack by a predatory fish as it is pulled through the water. The present invention is designed to naturally accept the shape of a baitfish 25 when attached to the lure body 20 enable the continued natural movement of the lure even after insertion of the baitfish 25. Predatory fishing lure 10 is divided into three main parts, the lure body portion 20, the lure head portion 21 and caudal fin portion 22. The body portion 20 generally similar in dimension and configuration to simulate a body half segment of a baitfish species 25 by which the body half segment includes the lure head portion 21 and caudal fin 22 bilaterally symmetrical from its lure head portion 21 to the caudal fin 22 to resemble half the shape of a baitfish. Predatory fishing lure 10 may generally include a separate realistic fish head 23 and a baitfish body strap 24 configured to secure together with the lure head portion 21 and the lure body portion 20, to form a body that replicates a baitfish 25 and can be used to attract prey fish species. The lure head portion 21 has a hole to which a fishing leader 33 may be secured by a snap swivel (not shown). The caudal fin 22 portion includes a hole to which a hook is secured via a snap swivel (not Shown). The lure body 20 can include recesses and/or pockets to accommodate features or accessories for example one or more hook(s) 26 attached to the bottom side of the lure body 20.

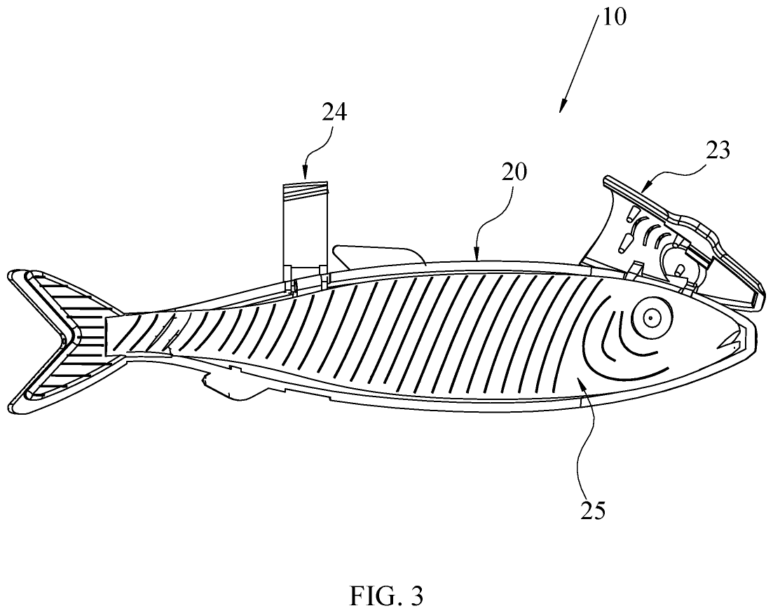

More specifically, as shown in FIG. 3 is a side view of the predatory fishing lure 10 of FIG. 1, shown in the open position and configured to accept the baitfish 25 which is similar in dimension to the predatory fishing lure 10. In addition, fish head 23 and baitfish body strap 24 attached to the lure body 20 are shown in an open position before securing the baitfish in the locking position.

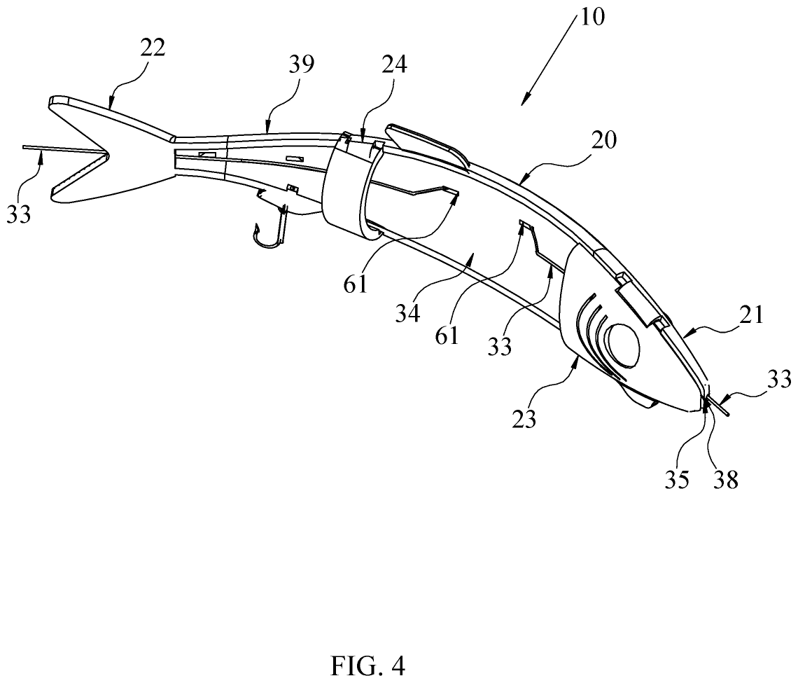

As generally shown in FIG. 4 is a perspective view of predatory fishing lure 10, showing the present invention having a lure body 20 comprises a concave interior surface 34 which is designed to accept a baitfish species 25 (not shown). Moreover, having the lure head 21 and the fish head 23 configured to secure together to form a cavity to accommodate a baitfish species 25 (not shown) and/or other features or accessories. The predatory fishing lure further comprises a lure body 20 having the second component of an baitfish body strap 24 configured to engage with baitfish species 25 (not shown) lower body portion 39 to firmly hold the body of the baitfish to the predatory fishing lure 10. In addition, the fishing leader 33 is guided in the front of the lure nose portion 35 of the lure head 21 from the line insertion hole 38. After passing through the opening on the line insertion hole 38 of the lure head 21 whereas the leader fishing leader 33 is inserted through the line hole 61 located on the lure body 20 so that the fishing leader 33, is not connected to the baitfish allowing the prey fish to be hooked without interference of the line, then the fishing leader 33 is guided out in the back end of the caudal fin 22 to receive the hook (not shown) at the lower edge of the caudal fin 22.

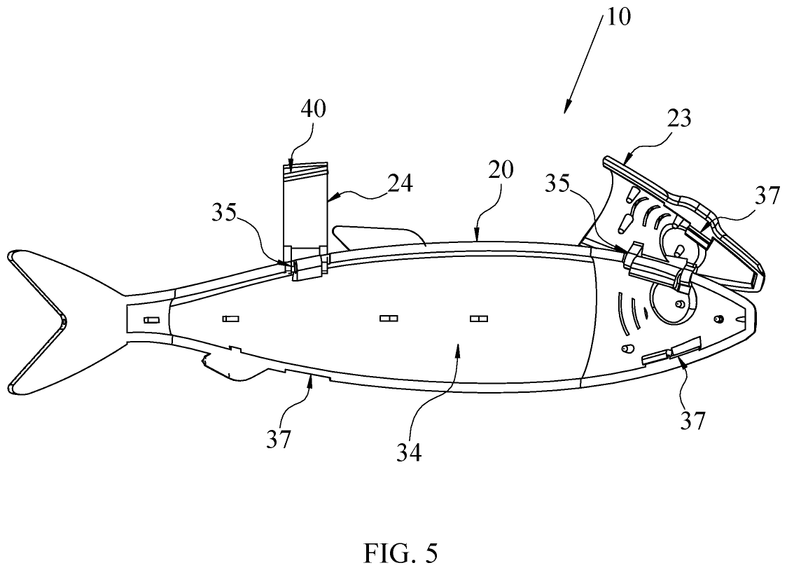

More specifically, as shown in FIG. 5 is a side view of the predatory fishing lure 10, shown with the fish head 23 and body strap 24 In a “open” position as depicted as ready to receive the baitfish species 25 (not shown) therein. In relation to the lure body 20 which features the head to body locking mechanism 40, referred to generally as the fish head 23 and body strap 24 which is separated from the lure body portion 20 whereas, the fish head 23 comprises a hinged 35 and locking mechanism 37 securing the two halves resulting in giving access to the baitfish and/or liquid scent holding bait chamber. Extending outwardly and away from the concave interior surface 34 is the second component of the head to body locking mechanism, referred to generally as the body strap 24 comprises a hinged 35 and locking mechanism 37 securing the baitfish species 25 (not shown) to the lure body 20.

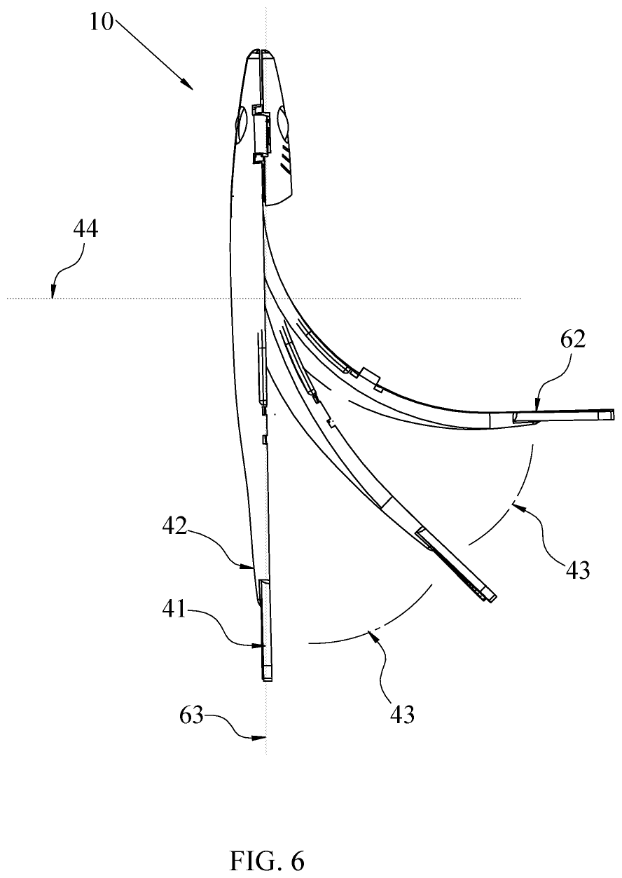

As best seen in FIGS. 6 and 6A illustrates the top view of a predatory fishing lure 10 having a bend in the tail portion 41 causing the predatory fishing lure 10 to roll in a circle either clockwise or counterclockwise to simulate a wounded baitfish like motion. To help visualize this multi-plane rotation, the tail portion 41 is illustrated in three positions in the both clockwise and counterclockwise direction. In the counterclockwise central position 63, the tail is horizontally centered position 42 with no rotation with the next position showing the present invention in a counterclockwise rotation 43 with respect to a horizontal plane 44 less than 45 degree or greater. The final position 62 show the tail portion 41 in a counterclockwise rotation with respect to a horizontal plane 44 less than 90 degree or greater. In the clockwise central position 63, as shown in FIG. 6A the tail is horizontally centered position 42 with no rotation with the next position showing the present invention in a clockwise rotation 64 with respect to a horizontal plane 44 less than 45 degree or greater. The final position 62 show the tail portion 41 in a clockwise rotation 63 with respect to a horizontal plane 44 less than 90 degree or greater. The bend in the predatory fishing lure 10 can be configured to assume the shape of another fish by adjusting the bend in the body and tail.

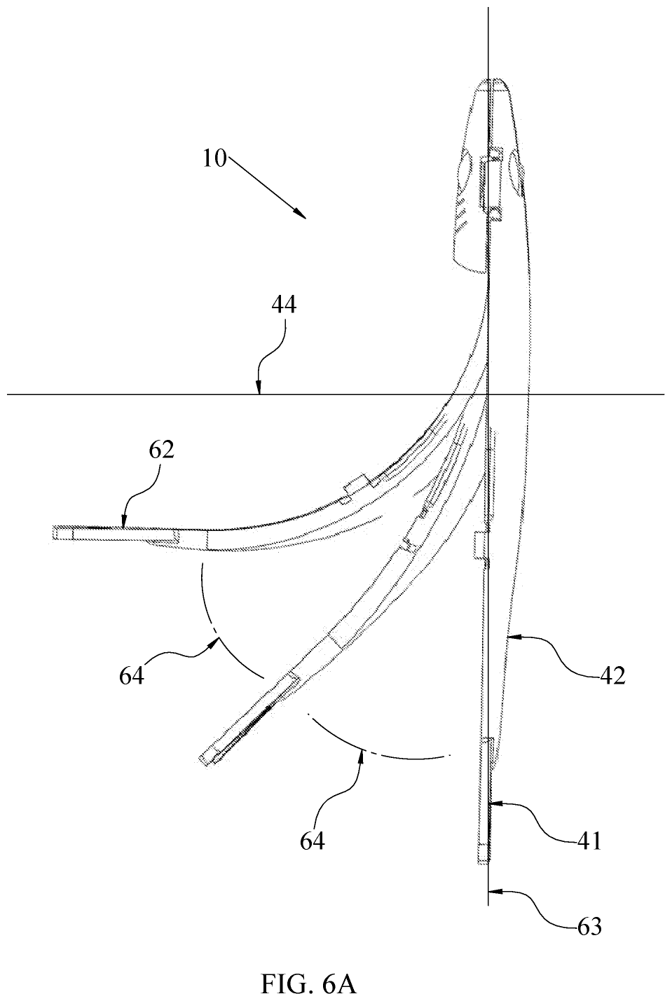

In accordance with the embodiment of the present invention FIG. 7, is top view of the predatory fishing lure 10, whereas the tail portion 41 may be configured to assume the shape of another prey fish species (not shown) by adjusting the twist in the caudal fin 22. Generally the caudal fin 22 can be rotatable around the longitudinal axis 45 in either clockwise or counterclockwise direction, for example can be set to 0 degrees, 90 degrees, 180 degrees or any other value.

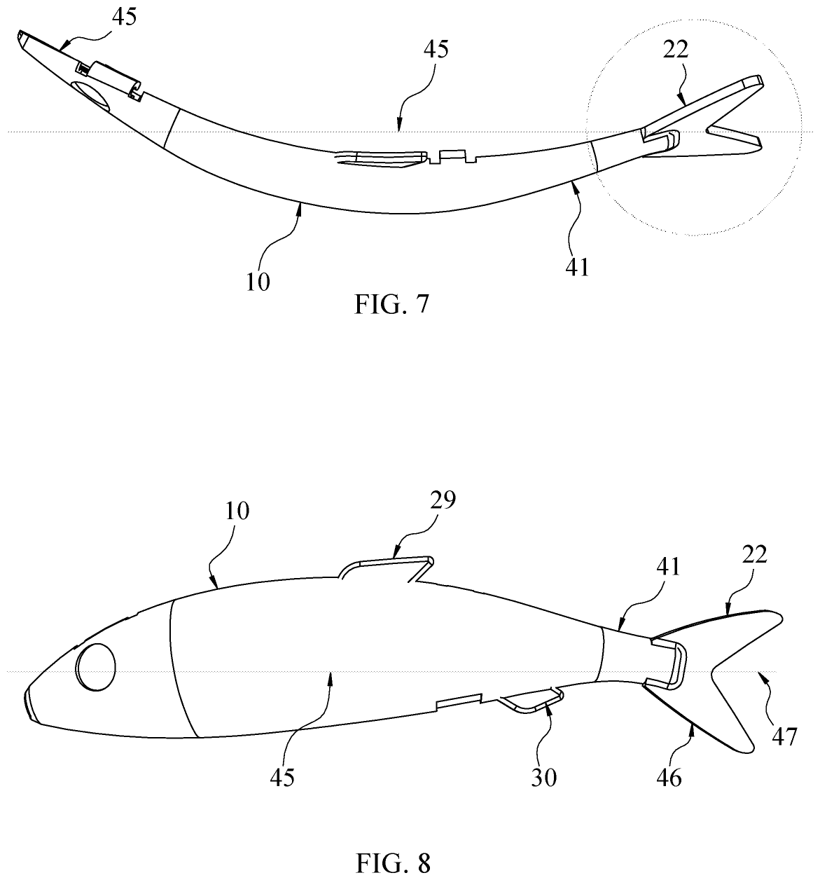

Moreover, as shown in FIG. 8 is a side view of the tail portion 41 may be angled downward 46 to achieve different action or performance from the predatory fishing lure 10. For example, when the tail portion 41 is angled downward 46 from the longitudinal axis 45 causing the predatory fishing lure 10 to move at tighter or wider roll.

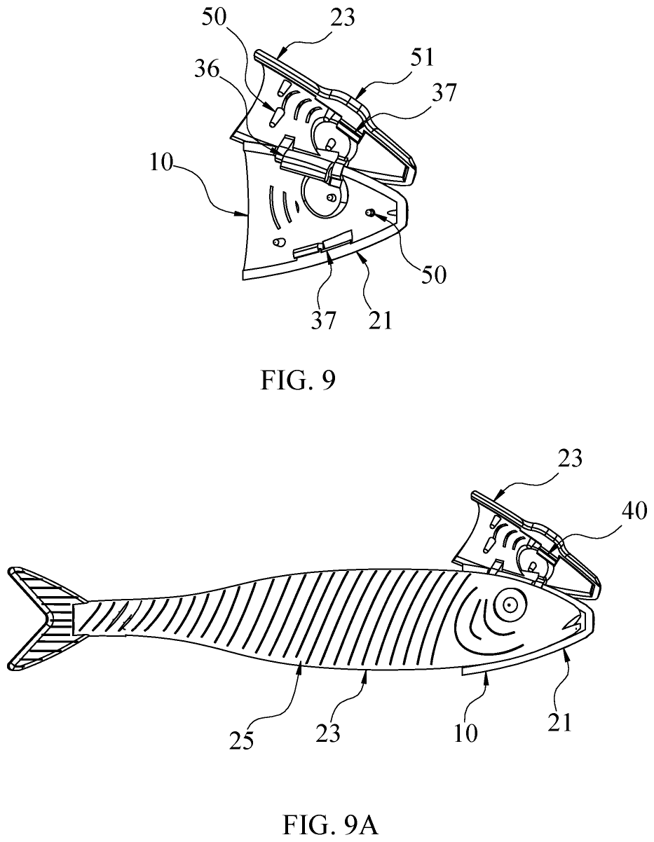

As best seen in FIG. 9 is a detail side view of FIG. 5 of predatory fishing lure 10, having an fish head 23 in the open position extending outwardly and away from the lure head 21 connected by an unrestrained single hinged mechanism 36 holding them together and forming a pivot. Wherein the lure head 21 having a locking mechanism 37 formed on the inner bottom edge of the lure head 21 and extended outward with respect to engaging the fish head 23 locking mechanism 37 located on the inner bottom edge of the fish head 23. In addition, the fish head 23 can be connected or disconnected from lure head 21 by engaging the fish head tab 51 located on the lower end of the fish head 23. The inner circumference of both the lure head 21 and the fish head 23 may have spikes 50 to secure the head of the baitfish species 25 shown in FIG. 9A to the lure located inside the bait head bait chamber.

Moreover, as shown in FIG. 9A is a side view of the of FIG. 9 of predatory fishing lure 10, having the baitfish species 25 inserted inside the bait head bait chamber before engaging the hinged and locking mechanism 40. When in the closing position the bait chamber is created by securing the fish head 23 and lure head 21.

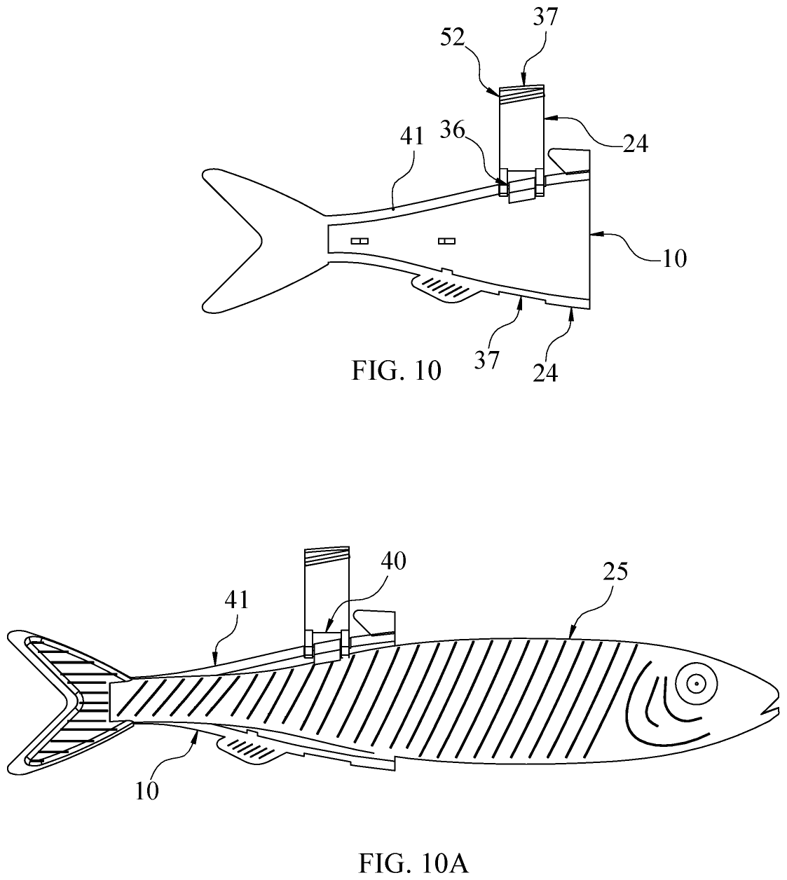

As generally shown in FIG. 10 is a detail side view of FIG. 5 of predatory fishing lure 10, having an body strap 24 in the open position extending outwardly and away from the tail portion 41 connected by an unrestrained single hinged mechanism 36 holding them together and forming a pivot. Wherein the body strap 24 having a locking mechanism 37 formed on the top edge of the body strap 24 and extended downward with respect to engaging the tail portion 41 locking mechanism 37 located on the inner bottom edge of the tail portion 41. In addition, the body strap 24 can be connected or disconnected from tail portion 41 by engaging the body tab 52 located on the top edge of the body strap 24.

Moreover, as shown in FIG. 10A is a detailed side view of the of FIG. 10 of predatory fishing lure 10, having the baitfish species 25 inserted inside the tail portion 41 before engaging the hinged and locking mechanism 40.

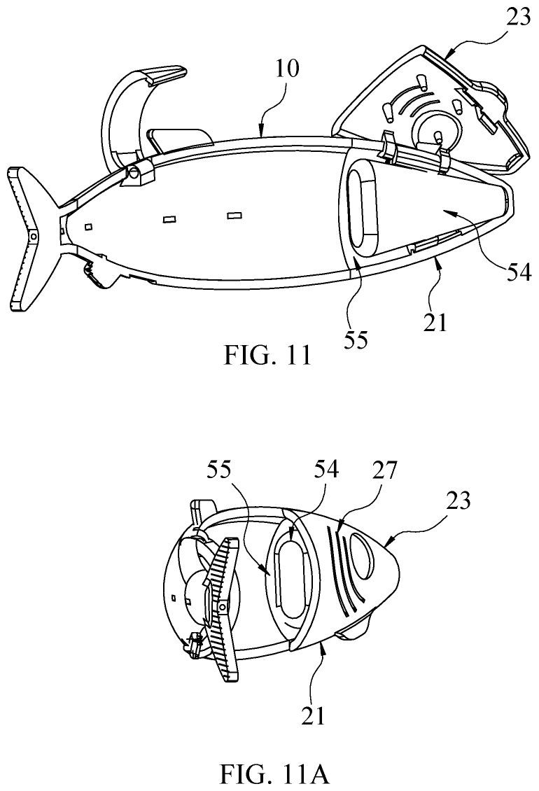

In accordance with the embodiment of the present invention FIG. 11, is an illustrated view of the predatory fishing lure 10, having the lure head 21 and the fish head 23 configured to secure together to form a bait chamber 55 to accommodate features or accessories. For example, the bait chamber 55 may be configured to accept a scent pad 54, chum, or pieces of baitfish (not shown) in lieu of an actual baitfish.

In relationship to FIG. 11, whereas FIG. 11A is a perspective view of the scent pad 54 located within the bait chamber 55 showing another unique feature in the way of gills 27 located on both the lure head 21 and the fish head 23 configured for emitting a powerful scent trail that attracts prey fish species. The gills 27 enable passage of water into and from the bait chamber 55 while the predatory fishing lure 10 is in the water, permitting the dispersal of scent and, in some instances, particles of the bait material (not shown in the Figures) placed within the bait chamber 55 into the surrounding water to further attract fish.

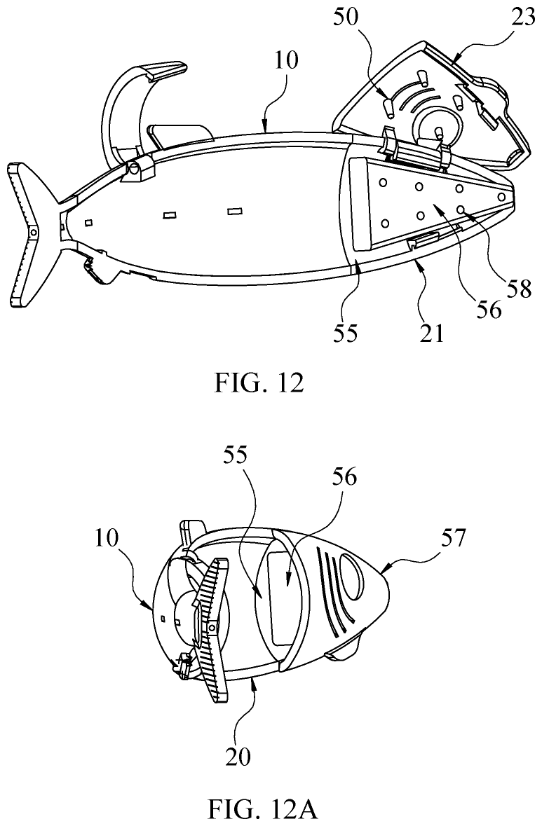

As shown in FIG. 12 is an illustrated view of the of predatory fishing lure 10, showing another unique feature to the predatory fishing lure 10 is the ability to add a weight 56 into the bait chamber 55 formed by the lure head 21 and the fish head 23 instead of scent or bait chunks. The weight 56 component may comprise of through holes 58 that the spikes 50 would interlock with to secure the weight in the bait chamber 55.

In relationship to FIG. 11, whereas FIG. 12A is a perspective view of the weight 56 located within the bait chamber 55. Respectively, the weight 56 causes the predatory fishing lure 10 to retain its downward and forward orientation relative to the head portion 57 of the lure body 20 irrespective of whether the lure body is in the side down or top side up orientation.

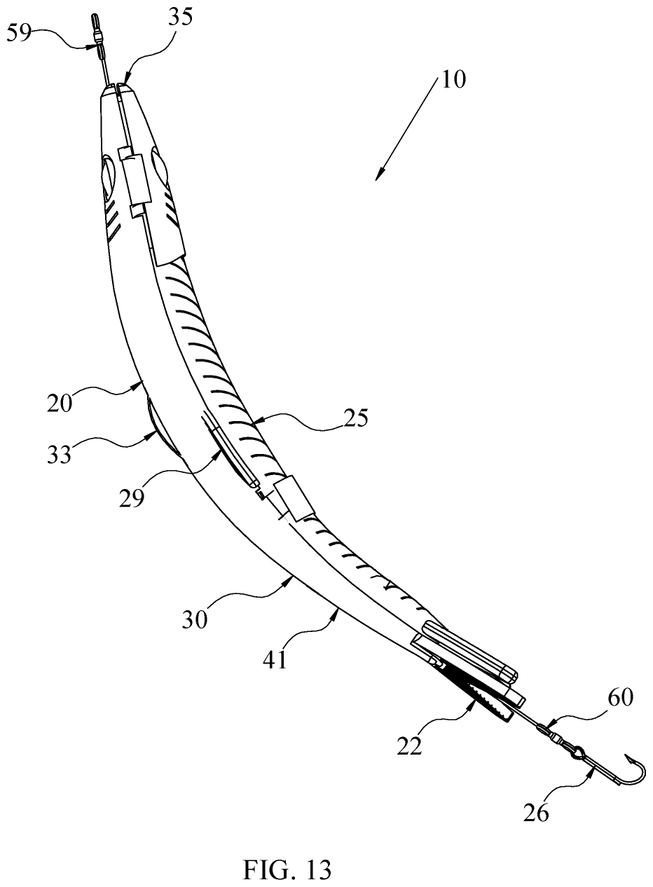

As best seen in FIG. 13 the predatory fishing lure 10, with a baitfish species 25 is generally connected to an end of the fishing line (not shown), which is connected to a fishing rod and a reel (not shown). The fishing line is threaded thru the lure nose 35 though the lure body 20 and exits out the caudal fin 22 of the tail portion 41. There may be a swivel 59 attached as well as hooks 26 at the tail of the lure. An additional barrel swivel 60 may be installed above lure nose 35 of the lure to ensure smooth lure rotation and roll. The predatory fishing lure 10 is then cast into areas of water where target species of fish may be found. The predatory fishing lure 10 may be skillfully moved in the areas of water to attract prey fish species and to encourage the target prey fish species to bite the predatory fishing lure 10. In some embodiments, the tail section 41 multi-plane rotation when pulled through water may cause eddies and vortices to form as the flow of water around the predatory fishing lure 10 changes from streamline to turbulent. In turn, eddies and vortices movement caused by the tail section 41, dorsal fins 29 and the anal fin 30 may produce a swimming motion optimized for attracting and fooling prey fish into biting the predatory baitfish lure 10.

What is claimed is:

1. A predatory fishing lure comprising:
a body being fish shaped in size and length with the body portion generally similar in dimension and configuration to simulate a body half segment of a baitfish species by which the body half segment includes the lure head portion and caudal fin bilaterally symmetrical from its lure head portion to the caudal fin to resemble half the shape of a baitfish and include a separate realistic fish head and a baitfish body strap configured to secure together with the lure head portion and the lure body portion, to form a body that replicates a baitfish and can be used to attract prey fish species; and
a body comprises a concave interior surface which is designed to accept a baitfish species moreover, having the lure head and the fish head configured to secure together to form a chamber to accommodate a baitfish species and/or other features or accessories, wherein a baitfish body strap configured to engage with baitfish species lower body portion to firmly hold the body of the baitfish to the predatory fishing lure; and
a tail portion consists of a bend clockwise up to 90 degrees with respect to a horizontal plane, a caudal fin rotate around the longitudinal axes in either clockwise or counterclockwise direction and a tail portion can be angled downward or upward.

2. The predatory fishing lure of claim 1 wherein having lure head portion and fish head connected by an unrestrained single hinged mechanism holding them together and forming a pivot and the lure head having a locking mechanism formed on the inner bottom edge of the lure head and extended outward with respect to engaging the fish head locking mechanism located on the inner bottom edge of the fish head and can be connected or disconnected from lure head by engaging the fish head tab located on the lower end of the fish head.

3. The predatory fishing lure of claim 1 wherein having an body strap connected by an unrestrained single hinged mechanism holding them together and forming a pivot and the body strap having a locking mechanism formed on the top edge of the body strap and extended downward with respect to engaging the tail portion locking mechanism located on the inner bottom edge of the tail portion and can be connected or disconnected from tail portion by engaging the body tab located on the top edge or bottom edge of the body strap.

4. The predatory fishing lure of claim 1 wherein the fishing leader is threaded through the lure nose, lure body and existing through the caudal fin allowing for the free movement of the lure to slide up the line once a fish is hooked, to not create a wedge or pivot point for the hook to be dislodged from the predatory fish's mouth.

5. The predatory fishing lure of claim 1 further comprising the lure head and the fish head bait chamber configured to accept a scent pad and for the chamber to include gills enable passage of water into the bait chamber for emitting a scent trail.

6. The predatory fishing lure of claim 1 wherein accessories such as a weight can be inserted into the bait chamber and locked in place.

7. The predatory fishing lure of claim 1 wherein the body has an outer surface which may contain coloring or textures to replicate prey fish species.
